(19) United States
(12) Patent Application Publication
(10) Pub. No.: US 2014/0007017 A1
(43) Pub. Date: Jan. 2, 2014

(54) SYSTEMS AND METHODS FOR INTERACTING WITH SPATIO-TEMPORAL INFORMATION

(71) Applicant: Marinexplore Inc., Sunnyvale, CA (US)

(72) Inventors: Rainer Sternfeld, Santa Clara, CA (US); André Karpistsenko, Tallinn (EE); Kalle Kägi, Tallinn (EE); Oleg Mürk, Tartu (EE); Kristian Paljasma, Hiiumaa (EE); Rando Valt, Tallinn (EE)

(21) Appl. No.: 13/927,987

(22) Filed: Jun. 26, 2013

Related U.S. Application Data
(60) Provisional application No. 61/665,068, filed on Jun. 27, 2012.
(60) Provisional application No. 61/721,299, filed on Nov. 1, 2012.

(51) Int. Cl. G06F 3/0481

(52) U.S. Cl. CPC G06F 3/0481
USPC 715/848; 715/764

(57) ABSTRACT

This disclosure relates to systems and methods for access, interaction, and/or visualization of spatial and/or spatio-temporal information associated with a variety of data sources and/or locations. In some embodiments, systems and methods described herein allow for interactive visualization of information included in one or more spatial and/or spatio-temporal data streams and/or other related information using an interface of a visual explorer system. In certain embodiments, the interface of the visual explorer system may allow a user to, among other things, visualize certain temporal and/or spatial aspects of spatial and/or spatio-temporal data through interaction with one or more temporal and/or spatial visualization controls.

### RELATED APPLICATIONS

This application claims the benefit of priority under 35 U.S.C. §119(e) to U.S. Provisional Patent Application No. 61/665,068, filed Jun. 27, 2012, and entitled “VISUAL EXPLORER OF SPATIAL DATA STREAMS”, and to U.S. Provisional Patent Application No. 61/721,299, filed Nov. 1, 2012, and entitled “INTERACTIVE VISUALIZATION OF DYNAMIC ENVIROMENT” both of which are hereby incorporated by reference in their entireties.

### BACKGROUND AND SUMMARY

The present disclosure relates generally to systems and methods for interacting with spatial information systems. More specifically, but not exclusively, the present disclosure relates to systems and methods for interacting with spatio-temporal information using a variety of suitable systems and/or human-machine interfaces.

Measuring and/or modeling of dynamic environments including, for example, planetary bodies of water, may generate spatial and/or spatio-temporal data streams associated with large volumes of data. Conventional spatial information systems may be highly specialized for a specific data source and/or location, and thus may not be suitable for use in connection with a variety of data sources and/or locations. Conventional systems may further provide limited means for interacting and/or exploring temporal aspects of information. Moreover, user interfaces associated with conventional spatial information systems may not be suitable for use in interacting with multiple data sources and/or locations.

Embodiments of the systems and methods disclosed herein may enable access, interaction, and/or visualization of spatial and/or spatio-temporal information associated with a variety of data sources and/or locations. In some embodiments, systems and methods described herein allow for interactive visualization of information included in one or more spatial and/or spatio-temporal data streams and/or other related information using an interface of a visual explorer system. Such data streams and/or other related information may be diverse and, in some embodiments, be associated with a plurality of spatially distributed data sources. In certain embodiments, the interface of the visual explorer system may allow a user to, among other things, visualize certain temporal and/or spatial aspects of spatial and/or spatio-temporal data through interaction with one or more temporal and/or spatial visualization controls. Such controls may allow a user to generate one or more visual maps and/or other visualizations relating to the spatial and/or spatio-temporal data. In yet further embodiments, the interface may allow a user to generate one or more visual animations (e.g., animated maps) relating to spatial and/or spatio-temporal data.

Further embodiments of the systems and methods disclosed herein may transform data provided by multiple data streams according to a common data model. In certain embodiments, the common data model may utilize a standardized time and coordinate system (e.g., a standardized three-dimensional coordinate system). Utilizing a common data model may allow a user to interact with data from a variety of data sources using the visual explorer system disclosed herein. In some embodiments, the common data model may, among other things, be transformed automatically to one or more custom data models allowing automatic transfer of data from systems that rely on other data models and/or be output to other standards and/or data models. In certain embodiments, dynamic filtering control may be utilized to allow for flexible querying of common data model information and/or dimensions/parameters of the common data model.

### BRIEF DESCRIPTION OF THE DRAWINGS

The inventive body of work will be readily understood by referring to the following detailed description in conjunction with the accompanying drawings, in which:

FIG. 1 illustrates an exemplary ecosystem for collecting, managing, and interacting with information provided by one or more data sources consistent with embodiments of the present disclosure.

FIG. 2 illustrates an exemplary interface of a visual explorer for interacting with a spatio-temporal information system consistent with embodiments of the present disclosure.

FIG. 3 illustrates another exemplary interface of a visual explorer for interacting with a spatio-temporal information system consistent with embodiments of the present disclosure.

FIG. 4 illustrates a flow chart of an exemplary method for responding to a service request issued by a user system consistent with embodiments of the present disclosure.

FIG. 5 illustrates a flow chart of an exemplary method of generating a service request consistent with embodiments of the present disclosure.

FIG. 6 illustrates an exemplary system that may be used to implement embodiments of the systems and methods of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

Embodiments of the systems and methods disclosed herein may be utilized in connection with the collection, management, access, interaction with, and/or visualization of spatial and/or spatio-temporal data associated with a variety of data sources and/or locations. In certain embodiments, systems and methods disclosed herein may be utilized in connection with one or more earth sciences related data streams, although other suitable types of information may also be used. For example, systems and methods disclosed herein may be utilized in connection with spatial and/or spatio-temporal data relating to the earth's oceans. As used herein, the terms spatial data, spatio-temporal data, information, data, and/or data stream may be used interchangeably. Systems and methods disclosed herein may allow for interactive visualization of information included in one or more spatial and/or spatio-temporal data streams and/or other related information using an interface of a visual explorer system.

Spatio-Temporal Data Ecosystem

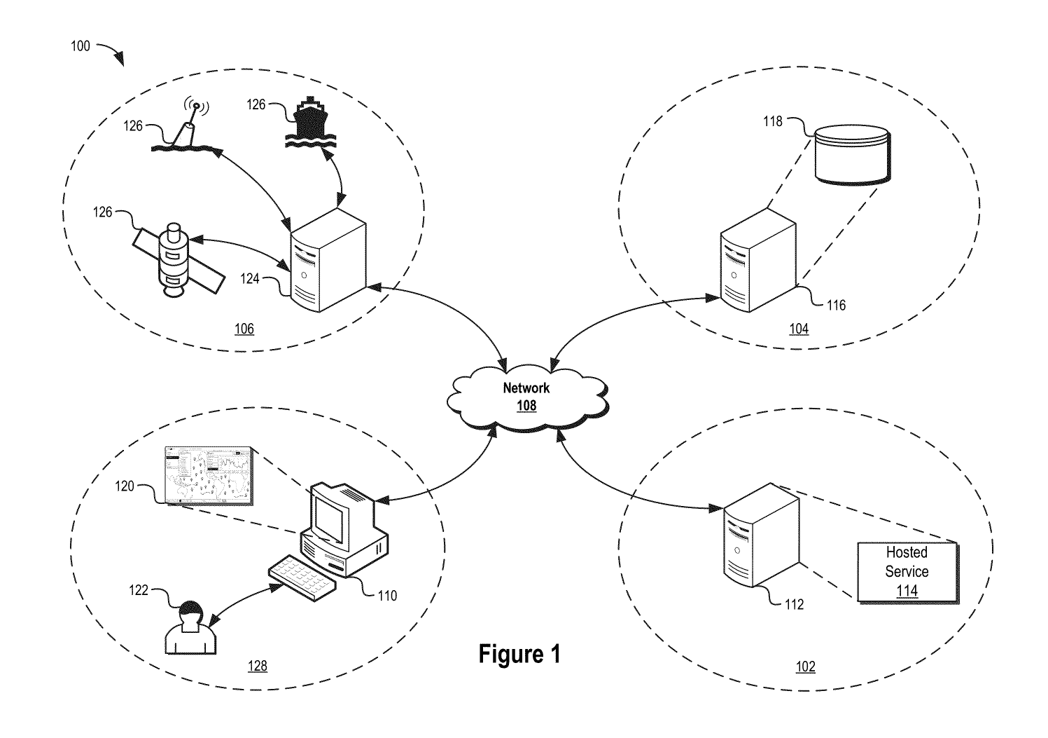

Systems and methods disclosed herein my provide for an interactive visual explorer system that may, at least in part, enable a user to explore, interact with, and/or visualize data collected by a variety of data sources at a variety of locations. FIG. 1 illustrates an exemplary ecosystem 100 for collecting, managing, and interacting with information provided by one or more data sources 126 consistent with embodiments disclosed herein. Various systems and/or devices illustrated in FIG. 1 may be associated with one or more conceptual layers including, without limitation, a service layer 102, a data storage layer 104, a data collection layer 106, and/or a user system layer 128.

The ecosystem 100 and/or its constituent layers 102-106, 128 may comprise one or more computing devices and/or systems that may include, without limitation, a data collection system 124, a data storage system 116, a service system 112, and/or a user system 110 communicatively coupled via a network 108. The connected systems 110, 112, 116, 124 may comprise a variety of computing devices and systems, including laptop computer systems, desktop computer systems, server computer systems, distributed computer systems, smartphones (e.g., the Apple® iPhone™, the Motorola® Droid®, and the BlackBerry® Storm™), tablet computers (e.g., the Apple® iPad™, the HP® Slate, and the Samsung® Galaxy™ Tablet), microcontroller-based embedded systems, and/or the like. As discussed in more detail below, the data collection system 124, data storage system 116, service system 112, and/or user system 110 may comprise at least one processor system configured to execute instructions stored on an associated non-transitory computer-readable storage medium. The data collection system 124, data storage system 116, service system 112, and/or user system 110 may further comprise software and/or hardware configured to enable electronic communication of information between the devices and/or systems 110, 112, 116, 124 via the network 108 and/or other communication channels using any suitable communication technology and/or standard.

Data Collection

One or more data sources 126 may be included in a data collection layer 106. The data sources 126 may provide one or more data streams to one or more communicatively coupled data collection systems 124. In certain embodiments, a data collection system 124 may be associated with a single data source 126, and may in some instances be integrated as a single system. In further embodiments, a data collection system 124 may receive and/or aggregate data streams provided by a plurality of data sources 126 at a variety of locations. Data sources 126 may be communicatively coupled with data collection systems 124 using any suitable communication and/or network methodology, including any of the communication and/or networking methodologies disclosed herein.

Consistent with embodiments disclosed herein, data sources 126 and associated data streams may be diverse. That is, data sources 126 may comprise, for example, a number of different types of data measurement, collection, and/or aggregation systems, may be associated with a variety of organizations and/or projects, may provide a number of different types of measurement information relating to a dynamic environment in a variety of different formats, and/or may provide spatially and/or temporally distributed data stream information. Embodiments of the systems and methods disclosed herein may allow a user to interact with and/or otherwise visualize data stream information provided by such diverse data sources in an integrated manner utilizing a visual explorer system.

The data sources 126 may comprise any suitable system for generating data relating to a dynamic environment. In some embodiments, data sources 126 may comprise systems providing information generated using one or more numerical models (e.g., computer models and/or algorithms generating data about a dynamic environment). In some embodiments, the data sources 126 may include one or more sensors and/or other measurement systems configured to generate such data. For example, in connection with generating data relating to the earth's oceans, data sources 126 may include, without limitation, aerial satellites, planes, weather ballons, mobile water platforms, autonomous vehicles (e.g., over and/or underwater vehicles, etc.), gliders, wave gliders, drifters, floats, buoys (e.g., surface, shallow water, or bottom measurement buoys, etc.), robot swarms, boats or other vessels, living creatures with associated sensors, moored stations, remotely operative vehicles, acoustic and/or sonar measurement devices (e.g., hydrophone arrays, sonobuoys, etc.), oil platforms, offshore wind farms, artificial habitats (e.g., over and/or underwater habitats), and/or any other suitable data collection and/or generation system implementing any suitable sensor and/or collection of sensors.

Data streams generated by data sources 126 may comprise a sequence of measurements (e.g., temporally and/or geographically-spaced measurements) provided by the data sources 126. Exemplary data streams include, without limitation, atmospheric information (e.g., air pressure, air temperature, humidity, wind speed, etc.), biological information (e.g., microorganism abundance, biological-related acoustic information, etc.), optical and radiation information (e.g., absorption, attenuation, reflectance, backscatter, transmissibity, etc.), chemical information (e.g., 02 levels, CO2 levels, chemical compositions, etc.), physical information (e.g., water conductivity, salinity, density, currents, wave height, temperature, pressure, flow, sea ice, etc.), and/or any other type of information relating to a dynamic environment including spatial and/or spatio-temporal information.

In certain embodiments, alternatively and/or in addition to measurement information, data streams generated by data sources 126 may comprise information relating to the data sources. For example, data streams may comprise metadata relating to a data source system. Such metadata may include, without limitation, system identification information, device status information (e.g., battery charge states or other device information associated with measurements taken at a particular point of time), types of data generated by data sources 126 (e.g., point data, gridded data, acoustic data, seismic data, sweet data, swath data, video data), types of measurements generated by data sources 126, organizations associated with the data sources 126 (e.g., organizations responsible for deploying and/or maintaining data sources 126), projects associated with the data sources 126 (e.g., research projects and/or initiatives), etc. Any other information that may be indirectly related to a dynamic environment (e.g., derived information) and/or information related to data sources 126 may also be included as part of data stream information.

In some embodiments, data streams received by data collection system 124 from data sources 126 may be in a variety of different formats (e.g., exchange formats) and/or models. For example, a data stream received by a data collection system 124 from a buoy-based sensor system may be formatted differently than a data stream received from a satellite system. Data collection systems 124 and/or data sources 126 may be associated with and/or operated by a variety of different organizations, each implementing a variety of different data exchange formats and/or methods in which the data is made accessible to other systems. In some embodiments, data collection systems 124 may store and/or exchange data streams provided by data sources 126 in the same and/or similar format that they are received. In yet further embodiments, data collection system 124 may transform data received by data sources 126 into one or more other formats, including standardized exchange formats for communication with other systems.

Data Storage

A data storage system 116 included in a data storage layer 104 may be communicatively coupled with the one or more data collection systems 124 via a network 108. The network 108 may comprise a variety of network communication devices and/or channels and may utilize any suitable communications protocols and/or standards facilitating communication between the systems disclosed herein. The network 108 may comprise the Internet, a local area network, a virtual private network, a seabed cable communication network, a mobile network, and/or any other communication network utilizing one or more electronic communication technologies and/or standards (e.g., Ethernet or the like). In some embodiments, the network 108 may comprise a wireless carrier system, such as a personal communications system (“PCS”), and/or any other suitable communication system incorporating any suitable communication standards and/or protocols. In further embodiments, the network 108 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network 108 may incorporate one or more satellite communication links. In yet further embodiments, the network 108 may utilize IEEE's 802.11 standards, Bluetooth®, ultra-wide band (“UWB”), Zigbee®, and or any other suitable standard or standards.

The data storage system 116 may receive one or more data streams from the data collection systems 124. In certain embodiments, data storage system 116 may request a list of available data streams from one or more data collection systems 124 and, upon selecting an available data stream from the list, may receive the selected data stream from the one or more data collection systems 124. In further embodiments, data collection systems 124 may provide the data storage system 116 with notifications regarding newly available data streams. In yet further embodiments, data streams provided to the data storage system 116 may be data streams generated using one or more computational models.

In some embodiments, data storage system 116 may subscribe to one or more data streams published by data collection system 124. Data storage system 116 may receive all data streams made available by data collection system 124 or a subset thereof. For example, the data storage system 116 may request to receive all future information associated with a particular data stream, may request to receive prior data stream information (e.g., historical data streams), and/or may request to receive data stream information associated with a particular period of time.

In certain embodiments, data storage system 116 may perform various functions relating to the scheduling of data stream information transfers between a data collection system 124 and the data storage system 116. For example, in certain embodiments, data stream information may be transferred to data storage system 116 according to a “pull” model, in which the data storage system 116 may refresh and/or initiate a transfer of data stream information from data collection system 124 based on, for example, a refresh interval and/or schedule. Alternatively or in addition, data stream information may be transferred to the data storage system 116 according to a “push” model, in which the data collection system 124 may initiate a transfer of data stream information to data storage system (e.g., based on new data stream information becoming available from data sources 126 or the like). In some embodiments, data stream information transfers and/or processing may be scheduled according to priority information associated with particular data streams and/or processing workloads of the data collection system 124 and/or data storage system 116.

Data stream information received by data storage system 116 may be stored for access by data storage system 116 and/or other associated systems (e.g., a service system 112 and/or a user system 110 as discussed in more detail below). In certain embodiments, data storage system 116 may store received data stream information in a database 118 and/or any other suitable storage structure and/or system (e.g., in distributed file systems supporting various storage mediums including physical hard drives, solid state storage, remote cloud-based storage such as Amazon Web Service S3™, EBS™, Glacier™, specialized storage virtualization systems such as FileTek™ and/or StorHouse™, or the like). In some embodiments, certain subsets of data stream information stored by data storage system 116 (e.g., information utilized by service system 112 on a regular basis) may be stored in one or more specified locations that may provide relatively high-speed access. In this manner, data stream information utilized on a regular basis stored by data storage system 116 may be accessed with increased responsiveness.

In some embodiments, the data storage system 116 may process and/or perform one or more transformations of data stream information received from the data collection system 124. For example, as discussed in more detail below, data storage system 116 may transform certain data stream information according to a common data model utilized by the visual explorer systems and methods disclosed herein. In further embodiments, the data storage system 116 may process and/or perform one or more operations that may impact other systems where data stream information is stored and/or is in use (e.g., a service system 112 and/or a user system 110). For example, one or more data streams may be “rolled-back” to reflect information obtained from a data collection system 124 at a particular point in time. In certain embodiments, “rolled-back” data stream information may be processed, transformed, and/or otherwise utilized to generate one or more data products associated with a previous time period. In further embodiments, such functionality may enable the data storage system 116 and/or other related systems to recover from a variety of errors, faults, and/or data collection, distribution and/or processing mistakes.

In yet further embodiments, certain data stream information may be restricted. For example, some data stream information may comprise private data stream information and/or data stream information associated with a particular user and/or organization. Similarly, access to certain data stream information may be subscription-based. In such embodiments, a user associated with a user system 110 that desires to utilize such data stream information may need to authenticate that their right to access such information (e.g., authenticate their identity with a data storage system 116, data collection system 124, and/or service system 112) via any suitable authentication process

Common Data Model

In certain embodiments, a common data model for spatial and/or spatio-temporal data may be used in connection with the systems disclosed herein. For example, in some embodiments, a data collection system 124 and/or data storage system 116 may transform different types of data stream information according to a common data model. Transformed data stream information may then be stored by the data storage system 116 (e.g., in database 118 and/or another suitable storage location). In further embodiments, data transformations implementing a common data model in connection with the systems and methods disclosed herein may be performed by a service system 112, a user system 110, and/or any other suitable system and/or systems. Transforming data stream information according to a common data model may allow for calculations, visualizations, and comparisons to be performed utilizing a variety of data in a variety of native formats (e.g., computations involving multiple data streams from multiple data sources).

The common data model may utilize a standardized time and/or coordinate system that, in certain embodiments, may be a three-dimensional coordinate system and/or other suitable coordinate systems (e.g., ED50, DTRS89, GRS80, NAVD88, SAD69, SRID, UTM, WGS84, etc.). In some embodiments, data stream information may be split into one or more data cells based on associated spatial coordinates and timestamps to allow processing of space-time regions. For example, spatial coordinates may define a 2-dimensional projection of a surface (e.g., the earth and/or an ocean's surface) or a 3-dimensional projection of a volume (e.g., a volume of water in the ocean). The generated data cells may be utilized by the systems and methods disclosed herein to visualize and/or perform calculations relating to a particular space-time region. In certain embodiments, data transformations according to the common data model may be performed using a sub-set of data stream information requested by a system for visualization and/or calculation purposes.

In some embodiments, spatial coordinate-based data cells may utilize a grid structure. Data points included in a data stream may be associated with a particular cell in the grid. In certain embodiments, one or more grid structures may be utilized in parallel to enable organization of the data cells in varying resolutions. For example, a rectangular data grid may be used for visualizing a particular parameter as a 2-dimensional heat map representing global ocean values at a particular depth. Similarly, an unstructured data grid could be used for visualizing a heat map on a coastline or seabed. In yet further embodiments, a suitable grid structure may be used for visualizing a 3-dimensional volume (e.g., a volume of the ocean or the like). In some instances, a grid structure may represent aggregated measurements and/or modeling values of a particular parameter during a specific time period.

Grid structures may have varying resolution depending on the granularity of associated spatial coordinates. Different resolutions may allow for visualizations and/or calculations having varying levels of detail. For example, in a high resolution grid, a data cell could contain data points associated with a 1 m×1 m×1 m volume of space, while in a lower resolution grid, a data cell could contain data points associated with a 1 km×1 km×1 km volume of space. In certain embodiments, resolution of cells and/or grid structures may be associated with certain longitude and/or latitude values.

Instead of and/or in addition to assigning values from data streams into a cell based on spatial coordinates, one or more lower resolution grid structures may be computed based on sampling and/or aggregating values from higher resolution grid structures. A variety of projections may be used to map spatial coordinates into a coordinate system used to visualize values in data cells. In certain embodiments, visualizations and/or calculations relating to a particular space-time region may be performed by data storage system 116 and provided to service system 112 and/or user system 110, although other suitable implementations are also contemplated.

Visual Explorer Service

A service system 112 associated with a service layer 102 may be communicatively coupled with the one or more data collection systems 124 and/or data storage systems 116 via network 108. In certain embodiments, the service system 112 may be configured to offer one or more remote and/or hosted services 114 to one or more connected systems. For example, in certain embodiments, the service system 112 may offer a visual explorer service consistent with embodiments disclosed herein as a hosted service 114. Systems connected to network 108 (e.g., user system 110) may be capable of communicating with the service system 112 and interacting with the hosted service 114.

In certain embodiments, the service system 112 may, among other actions, perform one or more computations on data stream information stored and/or managed by data storage system 116. For example, the service system 112 may receive a service request issued by the user system 110 to provide the user system 110 with information pertaining to one or more visualizations. In further embodiments, the service system 112 may receive a service request to provide a user system 110 with one or more numerical responses including, for example, statistical information relating to particular spatial and/or temporal coordinates (e.g., average temperatures, storm occurrences, etc.), textual responses, and/or any other desired responses and/or information that may be included in and/or derived from data stream information accessible by the service system 112 (e.g., accessible from data storage system 116 or the like).

The service system 112 may request corresponding data stream information from the data storage system 116, perform the processing and/or computations on the data stream information requested by the user system 110, and provide the results to the user system 110 (e.g., results in the form of a visualization and/or other related information). In some embodiments, the service system 112 may perform certain transformations of data received from the data storage system 116, calculate aggregate and/or statistical values based on the data, generate one or more visualizations and/or animations based on the data, generate information derived from the data based on one or more computational models, provide one or more textual responses, and/or the like.

In some embodiments, results of transformations, visualizations, and/or calculations performed by the service system 112 may be referred to as a data product. In certain embodiments, data products may be stored by the service system 112 and/or the data storage system 116 for future use and/or may be sent to a user computer system 110 in response to a service request. In some embodiments, certain data products may be stored in one or more specified locations that may provide relatively high-speed access. In this manner, stored data products utilized on a regular basis may be accessed with increased responsiveness.

Responses to service requests issued by user system 100 may be sent to the user system 110 and displayed to a user 122 via a visual explorer interface 120, as discussed in more detail below. For example, in response to a service request, the service system 112 may send the user system 110 one or more visualizations, maps, animations, charts, calculations, raw data information, and/or any other requested type of information or data product that may be viewed by a user 122 via the visual explorer interface 120.

In certain embodiments, a service request may create a session with the service system 112 that may allow the user system 110 to receive updates without issuing further service requests to the service system 112. For example, if new data stream information becomes available in data storage system 116 that matches a service request creating a session, the service system 112 may provide data products utilizing the new data stream information to the user system 110 without the user system 110 issuing a new service request. In some embodiments, creation of a session may allow a user system 110 to subscribe to updates from the service system 112 relating to prior service requests.

Optimized Service Responses

In certain embodiments, data sent to user system 110 may be reduced in time and/or location resolution based on a volume of data the user system 110 is capable of receiving and/or the visual explorer interface 120 is capable of displaying. For example, at a given time, the visual explorer interface 120 may only be capable of displaying information pertaining to a certain geographic region. Accordingly, data sent to the user system 110 at a particular time may be limited to only data pertaining to the displayed geographic region. In further embodiments, subsequent data measurements and/or data measurements that are close in vicinity may be averaged, original measurements may be dropped, and an averaged result may be sent to a user system 110 in response to a service request.

User System

A user system 110 associated with a user system layer 128 may be communicatively coupled with the one or more data collection systems 124, data storage systems 116, and/or service system 112 via network 108. In certain embodiments, the user system 110 may be configured to interact with one or more services offered by service system 112 (e.g., a hosted service 114 such as a visual explorer service) and/or access data generated and/or stored by data collection system 124 and/or data storage system 116.

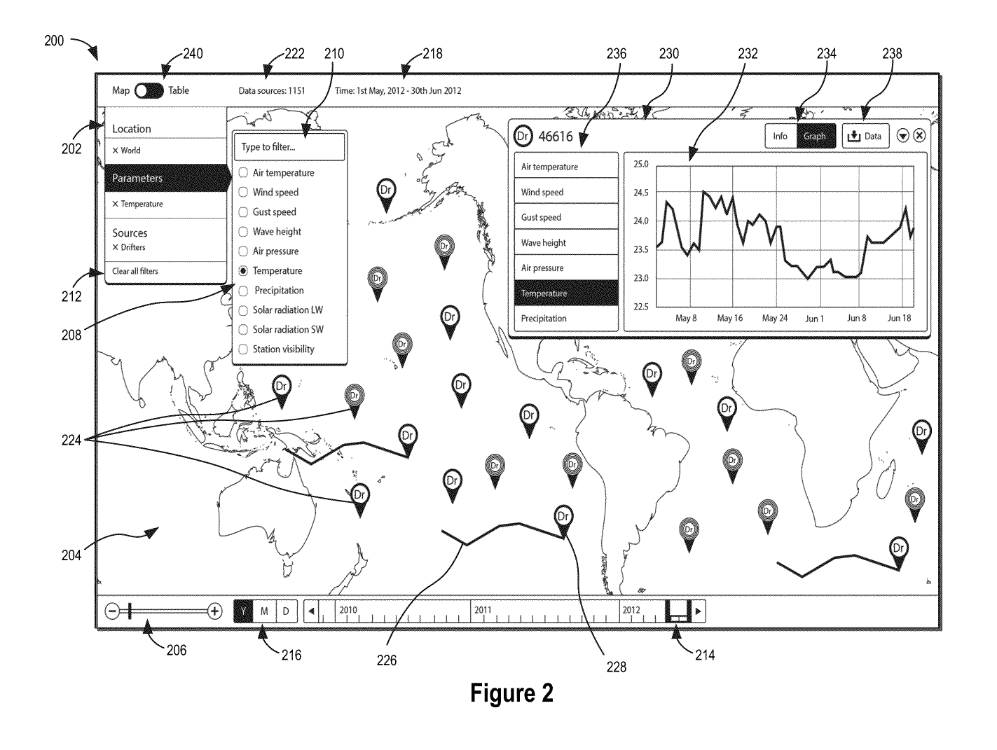

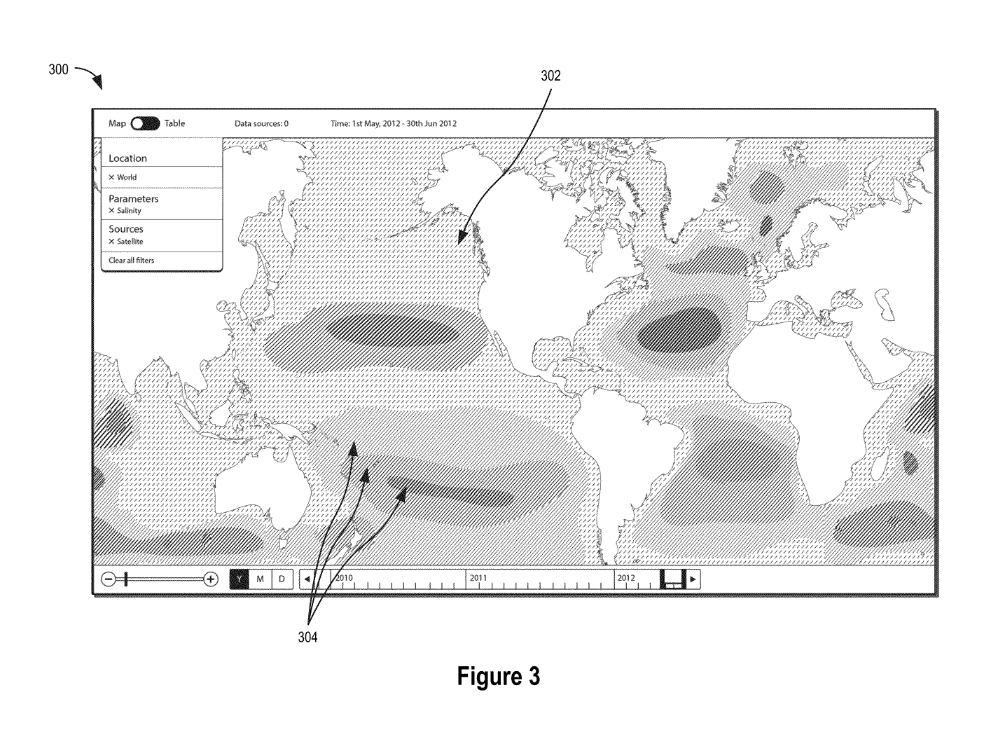

As discussed above, among other functions, the user system 110 may issue one or more service requests to a service system 112 in response to requests from a user 122 interacting with the user system 110 via a visual explorer interface 120. In certain embodiments, the visual explorer interface 120 may comprise any suitable interface configured to allow a user to interact with a visual explorer service. For example, using the visual explorer interface 120 a user may, among other things, view one or more visualizations and/or animations relating to data stream information and/or other data products, issue service requests to service system 112 via one or more controls, interact with data stream information and/or other data products, request information regarding available data sources 126, and/or the like. Exemplary embodiments of the visual explorer interface 120 are discussed in more detail below in reference to FIG. 2 and FIG. 3.

In certain embodiments, the visual explorer interface 120 may be associated with a native application executing on the user system 110 configured to interact with the systems as disclosed herein. In further embodiments, the visual explorer interface 120 may be an interface of a web-based application configured to interact with a remotely hosted application and/or service (e.g., hosted service 114) using, for example, a web-browser and/or any other suitable application.

It will be appreciated that a number of variations can be made to the architecture and relationships presented in connection with FIG. 1 within the scope of the inventive body of work. For example, certain system functionalities described above (e.g., functionalities of data sources 126, data collection system 124, data storage system 116, service system 112, and/or user system 110) may be integrated into a single system and/or any suitable combination of systems in any suitable configuration. Thus, it will be appreciated that the architecture of FIG. 1 is provided for purposes of illustration and explanation, and not limitation.

Visual Explorer Interface

Systems and methods disclosed herein may utilize a visual explorer interface to interact with a visual explorer service. For example, in certain embodiments, a visual explorer interface may facilitate interactive visualization of information included in one or more spatial and/or spatio-temporal data streams. FIG. 2 illustrates an exemplary interface 200 of a visual explorer for interacting with a spatio-temporal information system consistent with embodiments disclosed herein.

The interface 200 may, among other things, allow a user to interact with and/or visualize data collected from an environment and/or environment models. As discussed above, in certain embodiments, such data may be processed by a storage system, a service system, and/or a user system prior to being displayed on the interface 200. In some embodiments, a visualization may represent a dynamic environment in a particular space-time region and may be presented to a user as an image via the interface 200. In further embodiments, a visualization may comprise a sequence of images presented as an animation. Certain embodiments of visualizations may utilize one or more colors to represent different values of data and/or a distribution of the values which may depend, at least in part, on a visible region of space-time shown in the interface 200. Exemplary visualizations may include, without limitation, colored heat maps (e.g., heat maps representing global ocean temperatures at a particular depth), contour maps (e.g., contour maps representing approximate relative temperature boundaries), animations (e.g., moving images of current flows), and/or any other suitable type of visualization.

In certain embodiments, a visualization may include a time-series visualization. In some embodiments (e.g., heat-maps or the like), visualizations may show information displayed horizontally at a particular plane of interest (e.g., the ocean's surface). Alternatively or in addition, a visualization may show information relating to a vertical dimension. For example, a visualization may display information relating to a slice of the ocean from its surface to its bottom with associated dynamic quantities visualized.

Visualizations may further comprise acoustic Doppler current profile visualizations. In some embodiments (e.g., as in an acoustic Doppler current profile visualization or the like), quantizes may be presented on graph wherein the y-axis is based on a depth of a measurement and an x-axis presents time, allowing a user to view how quantities change in time. In further embodiments, visualizations may include 3-dimensional visualizations and/or maps. In certain embodiments, a user may interact with a 3-dimensional visualization using, for example, a holographic display or the like.

In certain embodiments, the exemplary interface 200 may be associated with a visual explorer service as described herein. In further embodiments, the exemplary interface 200 may be an interface of an application executing on a user system interacting with a visual explorer service. In certain embodiments, the interface 200 may be an HTML5-based interface displayed, for example, in a web-browser application. In further embodiments, the interface 200 may be a computer system application interface (e.g., a desktop application interface), mobile device interface, an interface of a plugin for one or more third-party applications, and/or any other type of interface. Certain elements of the exemplary interface 200 are described in more detail below.

The interface 200 may include a variety of controls allowing the user to interact with the visual explorer service and/or issue one or more service requests relating to data stream information (e.g., spatial data streams and/or related data products). In certain embodiments, the controls may include a dynamic filtering control menu 202. The filtering control menu 202 may, among other things, provide a number of filters that, when selected, may include and/or exclude certain data stream information from being displayed in interface 200. In certain embodiments, the filtering control menu 202 may enumerate a number of selections corresponding to variables and/or dimensions associated with a common data model implemented by a visual explorer service as disclosed herein. The filtering control menu 202 may allow for filtering of displayed data stream information according to, without limitation, the following exemplary common data model dimensions:
Location—a dimension that may identify the location of a data source within a coordinate system (e.g., a 3-dimensional coordinate system of earth or the like).
Parameters—a dimension that may group measurements of the same type conducted by one or more data sources (e.g., air temperature, wind speed, gust speed, wave height, air pressure, temperature, precipitation, solar radiation long wave, solar radiation short wave, station visibility, etc.). Parameters may include direct measurements as well as information and/or data products derived from measurements (e.g., averages over time, information obtained through models utilized measurements, etc.)
Sources—a dimension that may identify an organization that provided data streams and/or types of data sources.

These and other filtering control menu 202 variables and/or dimensions are discussed in more detail below.

In certain embodiments, the filtering control menu 202 may include a location selection menu. The location selection menu may provide a variety of locations (e.g., Northern hemisphere, Pacific Ocean, etc.) that when selected, change a relative view of a geographic area 204 displayed in the interface 200 (e.g., a map of the earth or the like) to a selected area. For example, a user may select a location corresponding to the Indian Ocean from the location selection menu. Based on this selection, the geographic view 204 displayed by the interface 200 may correspond with the Indian Ocean. In some embodiments, the geographic area 204 may be displayed as a Mercator projection, although other suitable types of maps and or geographic projections are also contemplated. In some embodiments, the location selection menu may allow for data products to be displayed associated with data sources within a selected geographic view 204.

In certain embodiments, the locations may be selected from a list of predefined locations. Alternatively or in addition, a location may be user defined (e.g., by entering relative latitude/longitude values and/or the like). In some embodiments, a location may be defined by a user by selecting a particular location and/or spatial region on a geographic view 204 displayed in interface 200 (e.g., using a cursor or other pointing device). For example, using a cursor or the like, a user may define a specific region included in geographic view 204 (e.g., utilizing a customizable polygon or fixed-shape drawing tool) for which a user would like to view available associated data stream information.

The geographic view 204 of interface 200 may also be changed using a zoom control 206. For example, using zoom control 206, a relative geographic view 204 displayed in the interface 200 may be expanded and/or contracted. This may allow a user to transition between viewing a particular region in detail and a less detailed view of a more global region. In certain embodiments, another zoom control (not shown) may be included that may allow a user to select a relative geographic view 204 at a particular relative height (e.g., altitude) and/or depth (e.g., ocean depth). Utilizing a second zoom control in this manner may allow for exploration and/or visualization of 3-dimensional spatial data on a 2-dimensional interface (e.g., a map).

The filtering control menu 202 may further include a parameter selection menu (e.g., menu 208). The parameter selection menu may provide a variety of parameters and/or types of measurements that, when selected, change the parameters and/or measurements displayed in interface 200. For example, a user may select that they wish to view temperature measurements. Based on this selection, the interface 200 may display temperature measurements within the geographic view 204. As discussed above, exemplary parameters and/or types of measurements may include, without limitation, air temperature, wind speed, gust speed, wave height, air pressure, temperature, precipitation, solar radiation long wave, solar radiation short wave, station visibility, and/or any other type of available parameter and/or measurement type.

In certain embodiments, the filtering control menu 202 may include a data source selection menu. The data source selection menu may provide a variety of available types of data sources that, when selected, control what information is displayed in interface 200. For example, a user may select that they wish to view measurements collected by drifters. Based on the selection, the interface 200 may display available measurements collected by drifters within the geographic view 204. Exemplary types of sources may include, without limitation, aerial satellites, planes, weather balloons, mobile water platforms, autonomous vehicles, gliders, wave gliders, drifters, floats, buoys, robot swarms, boats or other vessels, living creatures with associated sensors, moored stations, remotely operative vehicles, acoustic and/or sonar measurement devices, oil platforms, offshore wind farms, artificial habitats (e.g., over and/or underwater habitats), and/or any other suitable data collection and/or generation system implementing any suitable sensor and/or collection of sensors.

In certain embodiments, menus associated with the filtering control menu 202 may include a filtering field 210 allowing a user to filter available selections as desired. The filtering control menu 202 may display a number of selections from its constituent menus, thereby providing a user an indication as to the data shown in interface 200. The filtering control menu 202 may further include a clear filter icon 212, allowing a user to clear any prior filter selections.

In certain embodiments, the interface 200 may include one or more temporal controls 214-218. The temporal controls may include a time window selection toolbar 214 that may allow a user to specify a period of time for which the user would like to view data stream information. In certain embodiments, a user may select a period of time by selecting a start date and/or an end date using the time window selection toolbar 214. A selected time window may be displayed in a time window indication 218 included on the interface 200. In certain embodiments, a temporal resolution toolbar 216 may allow a user to change a temporal resolution of the time window selection toolbar 214 (e.g., between years, months, days, etc.). In yet further embodiments, an additional control may allow a user to select a particular point in time within a period of time specified by the time window selection toolbar (not shown).

Based on selections made by a user using the filtering control menu 202, a specified geographic view 204, and/or a specified period of time, a service request may be generated by a user system and sent to a service system requesting data stream information associated with the selections. This requested information may be returned to a user system and displayed in interface 200 (e.g., as a visualization, a menu, a chart, etc.). For example, as illustrated in FIG. 2, a user may wish to view temperature data obtained by ocean drifters during a 2-month period globally. A service request for this information may be issued, and a response may provide a user system with the requested information for display in interface 200. In certain embodiments, a type of visualization displayed by interface 200 may be changed (e.g., changed between a map, a table, etc.) using an visualization selection icon (e.g., icon 240). In yet further embodiments, information displayed by interface 200 may be displayed in a textual and/or numeral format.

A variety of other filters and/or controls may be utilized in connection with interface 200 including one or more user-defined filters. For example, as discussed above, a user may utilize a polygon drawing tool to define a region of interest within geographic view 204 for which the user would like to view available data stream information. In further embodiments, a user may define one or more parameter, data type, and/or any other desired type of data stream information control or filters. For example, a user may create and/or name a personalized filter that encompasses a number of different available types of data stream information. In still further embodiments, a user may define one or more time zones, calendar dates, and/or any other desired user-defined temporal controls and/or filters.

In certain embodiments, data sources associated with a particular service request may be shown in the visual explorer interface 200. For example, as shown, a plurality of data source icons 224 corresponding data sources responsive to a service request may be shown in a specified geographic view 204 of the interface 200. In some embodiments, a data source icon 224 may represent a single data source or a collection of data sources (e.g., array-based data sources, a group of data sources in close proximity relative to the resolution of the geographic view 204, and/or the like). In some embodiments, different data source icons 224 may be utilized for different types of displayed data sources. In further embodiments, different data source icons 224 may be used to represent single data sources than icons used to represent groups of data sources.

Certain data sources may be mobile and/or transient or transitory data sources. For example, a drifter (e.g., data source 228) may move a distance within a specified time window. In certain embodiments, one or more location paths and/or trajectories (e.g., path 226) of data sources may be displayed in the geographic view 204 of the interface 200. In some embodiments, a data source icon 228 may be selected and repositioned along the location path 226 to show data stream information from the associated data source at a time corresponding to when the data source was located at the repositioned location.

In some embodiments, when changing the geographic view 204 (e.g., expanding and/or contracting using zoom control 206), data source icons 224 may be split into icons representing individual data sources and/or grouped into an icon representing a group of data sources. For example, a number of grouped data sources previously associated with a single icon may each later be associated with discrete icons when the geographic view 204 is zoomed in. Similarly, a number of data sources previously associated with individual icons may later be associated with a single icon representing the group of data sources when the geographic view is zoomed out. In certain embodiments, this functionality may allow a user to access and/or view data sources on systems having limited screen sizes (e.g., screen sizes where a number of returned data sources are too large to be shown in the geographic view 204 at a particular geographic resolution).

In certain embodiments, a user may select a data source icon 224 and be provided with information and/or visualizations relating to data stream information associated with the data source and/or data sources. For example, as illustrated, a data source window 230 may be opened in the interface 200 when a data source icon 224 is selected. The data source window 230 may allow a user to select and view various parameters and/or measurements associated with the data source during the selected time window. In certain embodiments, selected parameters and/or measurements may be viewed in a graph 232 (e.g., a line graph), although other suitable arrangements are also contemplated. For example, a user may view temperature measurements associated with a particular data source during a selected time window in a line chart graph 232 included in data source window 230. In some embodiments, a user may be able to change between viewing a graph 232 and/or viewing numerical parameter and/or measurement information using a view selection menu 234 associated with the data source window 230. In certain embodiments, multiple data source windows 230 may be opened associated with different data sources 224. In this manner, a user may be able to compare different parameters and/measurements associated with different data sources 224 within the interface 200. In further embodiments, a data source window 230 may include additional filtering controls 236 may allow selection and/or filtering of, for example, parameters, devices, device type, data type, and/or any other information associated with a particular data source associated with the data source window 230.

In some embodiments, a user may select a download icon from the data source window 238 to download data stream information associated with a particular data source. In certain embodiments, a user may be provided an option as to a download format for the data stream information. Downloading data stream information may allow a user to utilize the data stream information separately from the visual explorer interface 200. For example, data stream information may be made available in a data exchange protocol that may be accessed by one or more other systems and/or software applications. In further embodiments, a user may share certain data stream information and/or service request responses (e.g., visualizations) with another user and/or entity, capture and/or transmit a “snapshot” of a particular visualization and/or other information shown in interface 200, transmit a link to another user and/or entity allowing access to a “snapshot” of a particular visualization and/or other information shown in interface 200, and/or the like. In certain embodiments, parameters and/or other indications associated with a particular service request may be shared between users and/or entities. Based on such information, a receiving user and/or entity may generate a new search request reflecting the shared search request information and receive an associated response from a service system.

In yet further embodiments, a user may select an upload icon (not shown) to upload data stream information that they would like to utilize in connection with the visual explorer system. Such information and/or information or visualizations derived therefrom may be displayed in interface 200 by a user's system. In further embodiments, the information may be transmitted to a service system and/or a data storage system and, consistent with embodiments disclosed herein, may be transformed according to a common data model for use in connection with the visual explorer system.

Optimized Service Layer Responses

In some embodiments, to reduce the volume of data exchanged between a server system and a user system in response to service requests, returned response information may limited based on a selected geographic view 204 area. For example, one or more viewport coordinates may be included in a service request defining the visible geographic view 204 area on the interface 200. Viewport coordinates may be utilized by a service system to filter out information associated with data sources that are not within the visible geographic view 204 area defined by the viewport coordinates. In certain embodiments, this may reduce the size of data stream information returned and/or used in generating a response to a service request, thereby reducing the volume of data exchanged between a service system and a user system and/or increasing the responsiveness of the service system to a service request.

Heat Map Visualizations

In certain embodiments, data stream information may be provided to a user system in the form of one or more visualizations that may include, for example, a heat map. FIG. 3 illustrates an exemplary visual explorer interface 300 showing a heat map 302 consistent with embodiments disclosed herein. Certain elements of the exemplary interface 300 may be similar to those illustrated in and described in reference to FIG. 2. Among other things, a heat map 302 may visualize relative ocean surface temperatures, relative ocean salinity measurements, and/or any other suitable data stream information.

Data cells associated with data stream information may be visualized in heat map 302 using one or more colors and/or patterns. For example, data cells may be visualized by assigning a color and/or pattern for different data values (e.g., data values 304) in each cell. A cell may be formed into a 2-dimensional image based on projecting longitude and latitude of the corresponding data into image coordinates. Assigning a color and/or pattern to a particular data cell value may depend on a variety of factors. In certain embodiments, assigning the color and/or pattern may depend on whether a value falls within one of a number of ranges between minimum and maximum values of the data. In some embodiments, the ranges may be the same and/or similarly sized. Alternatively or in addition, assigning color and/or pattern may be based on a distribution of data stream information within a particular geographic view area and/or viewport of interface 300, so that each color and/or pattern utilized has a similar number of associated data sources and/or data points.

In some embodiments, an image included in a visualization may be compressed before being transmitted to a user system by a service system to reduce an amount of data transferred between the systems. To facilitate higher quality visualizations, data tiles shown in the interface 300 for a visualization may be of a higher resolution than that supported by a physical interface of a user device. Visualizations may be pre-calculated and/or otherwise generated by a service system before being transferred to a user system for rendering. In other embodiments visualizations may be calculated and/or generated by a user device itself. In some embodiments, a user system may receive from a service system a pre-calculated visualization image in a simplified format responsive to a service request, and may perform additional processing before rendering the visualization in the interface. For example, a user system may receive a grey-scale pre-calculated visualization image from a service system, and may assign colors and/or patterns to the grey-scale image locally based on available information (e.g., minimum and maximum values in the image and/or underlying data distribution values included in the image).

Contour Map Visualizations

In certain embodiments, data stream information may be provided to a user system in the form of one or more visualizations that may include a contour map. For example, instead of and/or in addition to assigning colors and/or patterns to particular values of data, borders of spatial regions having similar values may be marked with a polygon line called a contour. In certain embodiments, such contour may also be associated with a particular color and/or pattern based on the underlying values. Contours may be assigned with particular data values according to a number of suitable methods, including based on accounting for a distribution of data values shown in an interface, associating the values with a particular range within the distribution, and assigning a contour line to values within the range.

In some embodiments, contours (e.g., colored contours) may be represented as vector graphics in an interface forming a contour map. To reduce the size of a contour map visualization, a number of points may be reduced by removing points from the map such that a resulting contour is within a distance tolerance from an original using one or more suitable image processing algorithms. In certain embodiments, a user may be shown a particular value associated with a contour by selecting the contour. Alternatively and/or in addition, a contour map may be provided to a user device for rendering in the form of a raster image and/or any other suitable type of image.

Animated Visualizations

Consistent with embodiments disclosed herein, visualizations of dynamic environments including, for example, heat maps, contour maps, 3-dimensional renderings, etc., may be sequenced based on associated timestamps into animations. Animated visualizations may, among other things, allow for interaction and exploration of dynamic patterns of underlying data streams.

In some embodiments, differences between subsequent visualizations may be encoded using a variety of video codecs (e.g., Ogg Theora, H.264, etc.) in transferring a sequence of visualizations to a user system. For example, a web-browsing application may receive an encoded video and decode it using, for example, a JavaScript library supported by a web-browsing application. In certain embodiments, the encoding may be performed by a service system in real-time as data streams are collected from one or more data sources. Alternatively, the encoding may be performed based on pre-calculated images and/or data cells stored by a data storage system.

Interactive Visualizations

In addition to the features detailed above, a variety of other interactive visualization controls may be utilized by the systems and methods disclosed herein. For example, in some embodiments, an interface may include “Play”, “Pause”, “Stop”, “Forward”, “Rewind”, and/or other similar icons that may allow a user to control and/or interact with an animated visualization. An interface may include one or more controls for changing colors and/or patterns included in a visualization, a transparence of a visualization, and/or a toggle button for selecting a type of visualization shown in a user interface. In certain embodiments, one or more service requests may be generated based on user input from such controls.

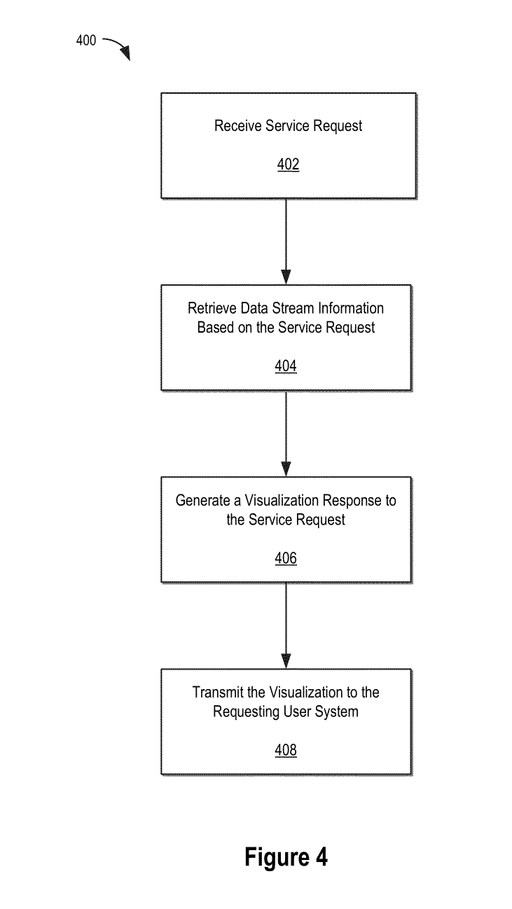

FIG. 4 illustrates a flow chart of an exemplary method 400 for responding to a service request issued by a user system consistent with embodiments disclosed herein. In certain embodiments, the method 400 may be performed by a service system providing a visual explorer service. A service system may receive a service request for a visualization from a user system 402. The service request may specify, among other things one or more location parameters (e.g., geographic regions and/or areas, latitude/longitude information, indications as to specific bodies of water, etc.), temporal parameters (e.g., specified time windows), measurement parameters (e.g., measurement types including, for example, temperature, wind speed, wave height, salinity, etc.), and/or data source type indications (e.g., satellites, buoys, etc.). Based on the service request, data stream information associated with a plurality of distributed data sources may be retrieved 404 (e.g., from a data storage and/or data collection system or the like). In certain embodiments, the data stream information may be formatted according to a common data model and include spatio-temporal information.

Using the data stream information, a visualization may be generated responsive to the service request 404. The visualization may include, without limitation, a heat map based on the data stream information, a contour map based on the data stream information, an animated visualization based on the data stream information, and/or any other requested type of visualization. Responsive to the service request, the visualization may be transmitted to the user system 408.

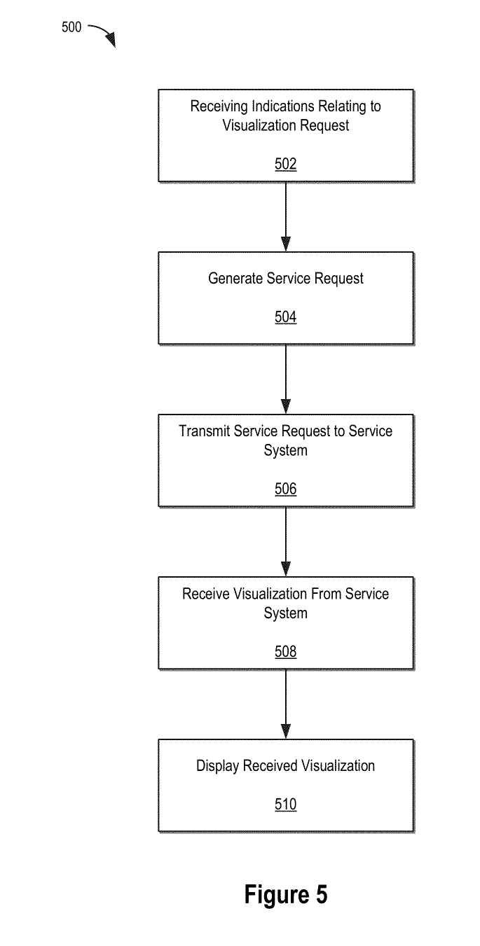

FIG. 5 illustrates a flow chart of an exemplary method 500 of generating a service request consistent with embodiments of the present disclosure. In certain embodiments, the method 500 may be performed by a user system interacting with a visual explorer service. The user system may receive one or more indications from a user relating to a visualization based on data stream information associated with a plurality of distributed data sources 502. The indications may include one or more location parameters, one or more measurement parameters, one or more temporal parameters, one or more data source type indications, and/or any other type of parameter. Based on the received indications, a service request may be generated 504 and transmitted 506 to a service system. The user system may receive visualization information from the service system responsive to the service request 508. Upon receipt, the user system may display a visualization corresponding to the visualization information on a suitable interface 510.

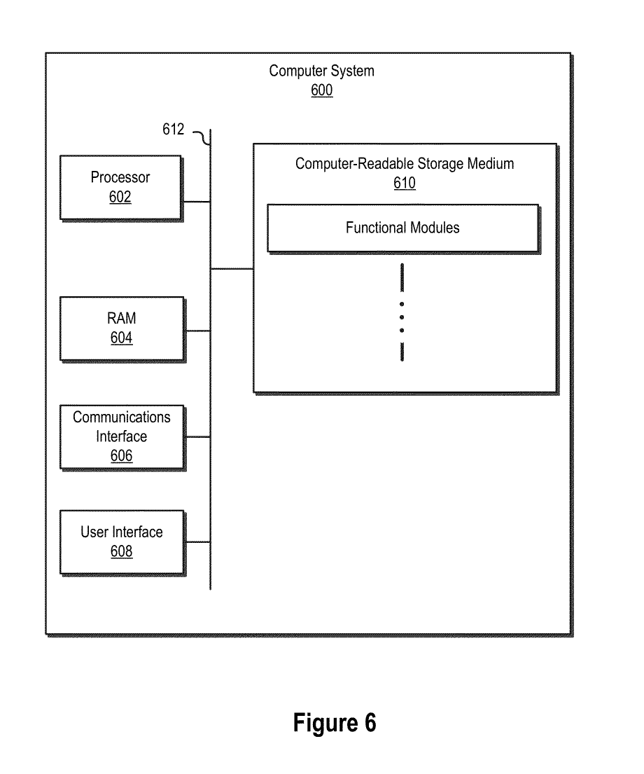

FIG. 6 illustrates a block diagram of an exemplary computer system 600 for implementing certain embodiments of the systems and methods disclosed herein. In certain embodiments, the computer system 600 may comprise a data collection system, a data storage system, a service system, a user system, and/or any other related system and/or systems. In certain embodiments, the computer system 600 may be a personal computer system, a server computer system, and/or any other type of system suitable for implementing the disclosed systems and methods. In further embodiments, the computer system 600 may be any portable electronic computer system or electronic device including, for example, a notebook computer, a smartphone, and/or a tablet computer.

As illustrated, the computer system 600 may include, among other things, one or more processors 602, random access memories (“RAM”) 604, communications interfaces 606, user interfaces 608, and/or non-transitory computer-readable storage mediums 610. The processor 602, RAM 604, communications interface 606, user interface 608, and computer-readable storage medium 610 may be communicatively coupled to each other via a data bus 612. In some embodiments, the various components of the computer system 600 may be implemented using hardware, software, firmware, and/or any combination thereof.

The user interface 608 may include any number of devices allowing a user to interact with the computer system 600. For example, user interface 608 may be used to display an interactive interface to a user, including any of the visual interfaces disclosed herein. The user interface 608 may be a separate interface system communicatively coupled with the computer system 600 or, alternatively, may be an integrated system such as a display interface for a laptop or other similar device. In certain embodiments, the user interface 608 may comprise a touch screen display. The user interface 608 may also include any number of other input devices including, for example, keyboard, trackball, and/or pointer devices.

The communications interface 606 may be any interface capable of communicating with other computer systems and/or other equipment (e.g., remote network equipment) communicatively coupled to computer system 600. For example, the communications interface 606 may allow the computer system 600 to communicate with other computer systems (e.g., computer systems associated with external databases and/or the Internet), allowing for the transfer as well as reception of data from such systems. The communications interface 606 may include, among other things, a modem, an Ethernet card, and/or any other suitable device that enables the computer system 600 to connect to databases and networks, such as LANs, MANs, WANs and the Internet.

The processor 602 may include one or more general purpose processors, application specific processors, programmable microprocessors, microcontrollers, digital signal processors, FPGAs, other customizable or programmable processing devices, and/or any other devices or arrangement of devices that are capable of implementing the systems and methods disclosed herein. The processor 602 may be configured to execute computer-readable instructions stored on the non-transitory computer-readable storage medium 610. Computer-readable storage medium 610 may store other data or information as desired. In some embodiments, the computer-readable instructions may include computer executable functional modules. For example, the computer-readable instructions may include one or more functional modules configured to implement all or part of the functionality of the systems and methods described above.

It will be appreciated that embodiments of the system and methods described herein can be made independent of the programming language used created the computer-readable instructions and/or any operating system operating on the computer system 600. For example, the computer-readable instructions may be written in any suitable programming language, examples of which include, but are not limited to, C, C++, Visual C++, and/or Visual Basic, Java, Perl, or any other suitable programming language. Further, the computer-readable instructions and/or functional modules may be in the form of a collection of separate programs or modules, and/or a program module within a larger program or a portion of a program module. The processing of data by computer system 600 may be in response to user commands, results of previous processing, or a request made by another processing machine. It will be appreciated that computer system 600 may utilize any suitable operating system including, for example, Unix, DOS, Android, Symbian, Windows, iOS, OSX, Linux, and/or the like.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a Bernoulli drive, a magnetic disk, a punch card, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method performed by a system comprising a processor and a non-transitory computer-readable storage medium storing instructions that, when executed, cause the processor to perform the method, the method comprising:
receiving a service request from a user system relating to a plurality of data streams associated with a plurality of diverse distributed data sources, the service request comprising a spatial indication and a temporal indication;
retrieving the plurality of data streams based in part on the spatial indication and the temporal indication;
generating a response to the service request based on the retrieved plurality of data streams, the response being derived from the plurality of data streams; and
transmitting the response to the user system.

2. The method of claim 1, wherein the response comprises a visualization, the visualization being derived from the plurality of data streams.

3. The method of claim 1, wherein the response comprises a textual response.

4. The method of claim 1, wherein the response comprises a numerical response.

5. The method of claim 2, wherein the visualization comprises at least one of a heat map, a contour map, a time-series visualization, a three-dimensional visualization, an acoustic Doppler current profile, and an animated visualization based on the plurality of data streams.

6. The method of claim 2, wherein the visualization comprises a plurality of colors, each color being associated with at least a portion of the retrieved plurality of data streams based on an overall distribution of the plurality of data streams within a view of a user interface of the user system.

7. The method of claim 1, wherein the retrieved plurality of data streams comprise information provided by the plurality of diverse distributed data sources formatted according to a unified spatio-temporal coordinate system.

8. The method of claim 1, wherein the service request further comprises a data source indication and the plurality of data streams are further retrieved based in part on the data source indication.

9. The method of claim 1, wherein the service request further comprises a parameter type indication and the plurality of data streams are further retrieved based at least in part on the parameter type indication.

11. The method of claim 1, wherein the service request further comprises an indication of an organization associated with one or more data sources, there plurality of data streams being further retrieved based at least in part on the indication of the organization.

12. The method of claim 1, wherein the service request further comprises a data source type indication and the plurality of data streams are further retrieved based at least in part on the data source type indication.

13. The method of claim 1, wherein the spatial indication comprises a user-defined region of interest.

14. The method of claim 13, wherein the user-defined region of interest comprises a region of interest defined by a user using a polygon tool.

15. The method of claim 1, wherein the temporal indication comprises a user-defined period of time.

16. The method of claim 1, wherein the temporal indication comprises a user-defined point in time.

17. The method of claim 1, wherein at least one of the data sources comprises a transient data source and the response comprises an indication of a path of the transient data source within a period of time defined by the temporal indication.

18. The method of claim 1, wherein the response comprises metadata information regarding the plurality of diverse distributed data sources.

19. A computer-readable storage medium storing instructions that, when executed by a processor, cause the processor to perform a method comprising:
receiving a service request from a user system relating to a plurality of data streams associated with a plurality of diverse distributed data sources, the service request comprising a spatial indication and a temporal indication;
retrieving the plurality of data streams in part on the spatial indication and the temporal indication;
generating a response to the service request based on the retrieved plurality of data streams, the response being derived from the plurality of data streams; and
transmitting the response to the user system.

20. The computer-readable storage medium of claim 19, wherein the visualization comprises at least one of a heat map, a contour map, a time-series visualization, a three dimensional visualization, an acoustic Doppler current profile, and an animated visualization based on the plurality of data streams.
